(19) United States
(12) Patent Application Publication
(10) Pub. No.: US 2014/0223145 A1
(43) Pub. Date: Aug. 7, 2014

(54) Configurable Reduced Instruction Set Core

(71) Applicant: INTEL CORPORATION, Santa Clara, CA (US)

(72) Inventors: Srihari Makineni, Portland, OR (US); Steven R. King, Portland, OR (US); Zhen Fang, Portland, OR (US); Alexander Redkin, Saint-Petersburg (RU); Ravishankar Iyer, Portland, OR (US); Pavel S. Smirnov, St. Petersburg (RU); Dmitry Gusev, St. Petersburg (RU); Dmitri Pavlov, St. Petersburg (RU); May Wu, Portland, OR (US)

(73) Assignee: Intel Corporation, Santa Clara, CA (US)

(21) Appl. No.: 13/992,797

(22) PCT Filed: Dec. 30, 2011
(86) PCT No.: PCT/US11/68016

§ 371 Date: Jun. 10, 2013

(51) Int. Cl. G06F 9/30

(52) U.S. Cl. CPC G06F 9/30076
USPC 712/220

(57) ABSTRACT

A processor may be built with cores that only execute some partial set of the instructions needed to be fully backwards compliant. Thus, in some embodiments power consumption may be reduced by providing partial cores that only execute certain instructions and not other instructions. The instructions not supported may be handled in other, more energy efficient ways, so that, the overall processor, including the partial core, may be fully backwards compliant.

### BACKGROUND

This relates generally to computing and particularly processing.

In order to be compatible with previous generations of processors, a subsequent generation generally includes support for legacy features. Over time, some of these legacy features become less and less commonly used since developers tend to revise their programs to work with the most current instruction sets. As time goes on, the number of legacy instructions that need to be supported continually increases. Nonetheless these legacy instructions may be executed less and less often.

### BRIEF DESCRIPTION OF THE DRAWINGS

Some embodiments are described with respect to the following figures:

FIG. 1 is a flow chart for one embodiment of the present invention;

FIG. 2 is a schematic depiction of one embodiment to the present invention;

FIG. 3 is a flow chart for another embodiment to the present invention;

FIG. 4 is a flow chart for still another embodiment to the present invention;

FIG. 5 is a hardware depiction for yet another embodiment to the present invention;

FIG. 6 is a flow chart for another embodiment; and

FIG. 7 is a schematic depiction of one embodiment.

### DETAILED DESCRIPTION

In accordance with some embodiments, a processor may be built with a partial core that only executes a partial set of the total instructions, by eliminating some instructions needed to be fully backwards compliant. Thus, in some embodiments power consumption may be reduced by providing partial cores that only execute certain instructions and not other instructions needed to be backwards compliant. The instructions not supported may be handled in other, more energy efficient ways, so that, the overall processor, including the partial core, may be fully backwards compliant. But the processor core may operate on the bulk of the instructions that are used in current generations of processors without having to support legacy instructions. This may mean that in some cases, the partial core processors may be more energy efficient.

For example, a partial core may eliminate a variety of different instructions. In one embodiment, a partial core may eliminate microcode read-only memory dependencies. In such case, the partial core instructions are implemented as a single operation instruction. Thus, the instructions get directly translated in hardware without needing to fetch corresponding micro-operations from the microcode read-only memory as is commonly done with complete or non-partial processors. This may save a significant amount of microcode read-only memory space.

In addition, only a subset of those instructions that are available on complete cores are actually used by modern compilers. As a result of architecture evolution over the last couple of decades, commercial instruction set architectures have many obsolete or non-useful instructions that can be eliminated for efficiency but at the cost of some lack of backwards compatibility.

Features from previous generations like 16-bit real mode from the Microsoft Disk Operating System (DOS) days and segmentation based memory protection architecture, local and global descriptor tables are being carried forward for backward compatibility reasons. But most modern operating systems do not need or use these features anymore. Thus, in some embodiments these features may simply be eliminated from partial cores.

Thus, in one embodiment, the partial core may be legacy-free or non-backwards compliant. This may make the core more energy efficient and particularly suitable for embedded applications. Other examples may include reducing the number of floating point and single-instruction multiple data instructions as well as support for caches. Only integer and scalar instructions set architecture subsets may be implemented in one embodiment of a partial core. The same idea can be extended to floating point and vector (single instruction multiple data) instruction sets as well as to features typically implemented by full cores. The partial core is simply an implementation of a subset architecture that in some embodiments may be targeted to embedded applications. Other implementations of a subset architecture include different numbers of pipelined stages and other performance features like out-of-order, super scalar caches to make these partial cores suitable for particular market segments such as personal computers, tablets or servers.

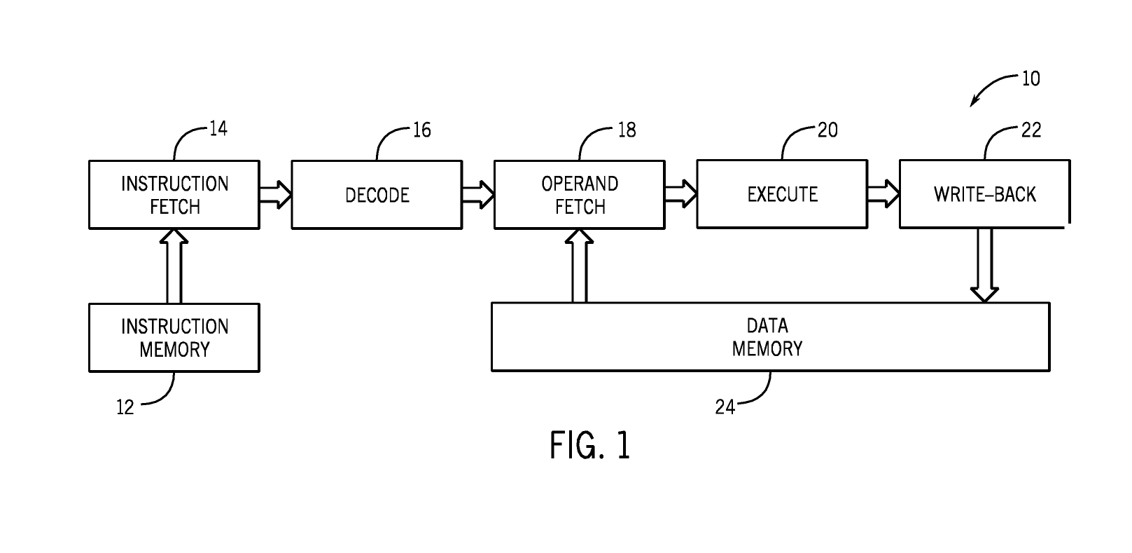

Thus referring to FIG. 1, an instruction memory 12 provides instructions to an instructions fetch unit 14 in a pipeline 10. Those instructions are then decoded at the decode unit 16. Operand fetch 18 fetches operands from a data memory 24 for execution at execute unit 20. And the data is written back to the data memory 24 at write-back 22.

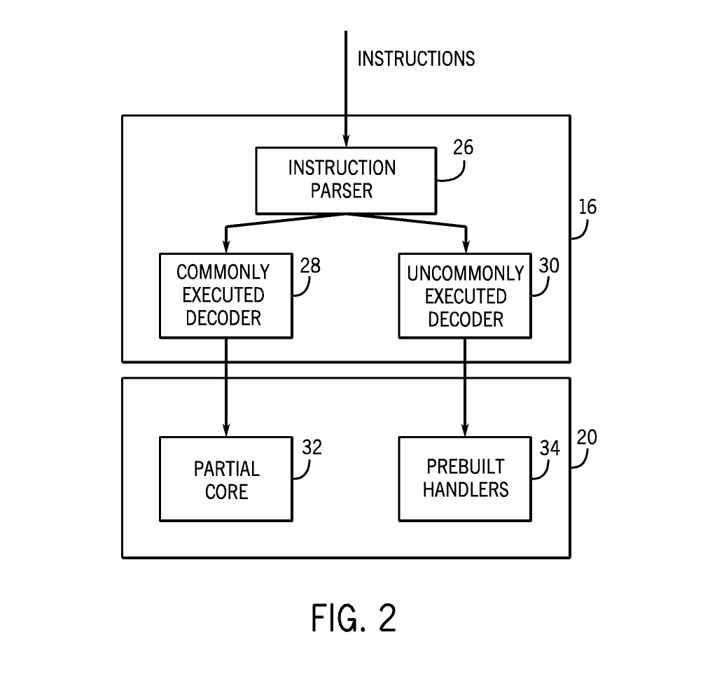

In order to achieve full backwards compatibility, unsupported instructions may be handled in different ways. According to one embodiment, shown in FIG. 2, a full decoder 16 may be provided in the pipeline 10. This decoder, at the time of full instruction decoding, detects unimplemented instructions and invokes prebuilt handlers 34 in execution unit 20 for those instructions. These pre-built handlers are dedicated designs that handle a particular instruction or instruction type. These pre-built handlers can be software or hardware based.

This approach may use a full-blown or complete decoder that speeds up detection of unsupported instructions and execution of execution handles. These pre-built handlers can be software or hardware based.

This full blown decoder speeds up detection of unsupported instructions and execution of execution handlers. The decoder may be divided into two parts. One part decodes commonly executed instructions and the second part decodes less frequently used instructions.

Thus referring to FIG. 2, the instructions are received by decode unit 16. In this embodiment, the decode unit 16 may include an instruction parser 26 that detects which instructions are supported by the partial core 32 (which may be described as commonly executed instructions) and which instructions are not supported (which may be called less commonly or uncommonly executed instructions). The instructions that are supported by the partial core are decoded by a commonly executed decoder 28 and passed to the partial core 32. Instructions that are uncommonly executed or unsupported are decoded by the decoder 30 and handled by pre-built handlers 34 in the execute unit 20 in one embodiment.

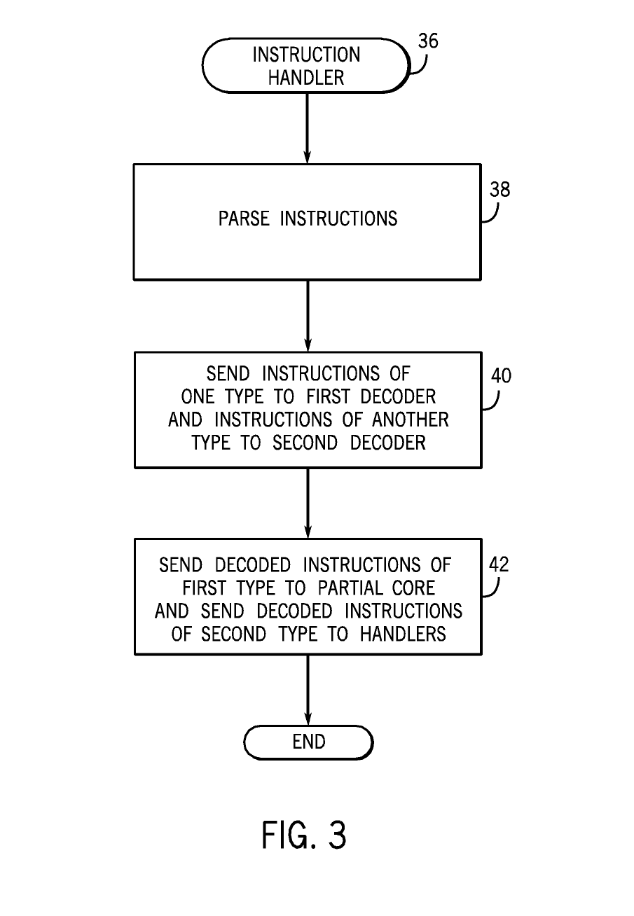

In some embodiments, a sequence 36 shown in FIG. 3, may be implemented in software, firmware and/or hardware. In software and firmware embodiments the sequence may be implemented by computer executed instructions stored in a non-transitory computer readable medium such as an optical, semiconductor or magnetic storage.

The sequence 36, shown in FIG. 3 begins by parsing the instructions as indicated in block 38. Namely the instructions may be parsed based on identifying instructions that are supported by the partial core and instructions that are not supported by the partial core. In one embodiment the supported instructions are the commonly executed instructions. In other embodiments, particular instructions may be parsed out because they are ones that are supported by the partial core.

As indicated in block 40 the instructions of one type are sent to the first (commonly executed) decoder 28 and instructions of the second type are sent to the second 41 (uncommonly executed) decoder 30. Then the decoded instructions of the first type are sent to the partial core and the decoded instructions of the second type are sent to the prebuilt handlers 34 as shown in block 42.

According to another embodiment, a core may generate an undefined instruction exception. This may be an existing exception or a newly defined special exception. The exception may be generated when an instruction is encountered that is unsupported by the partial core. Then a software or binary translation layer may get control of execution or resolve the exception. For example, in one embodiment the binary translation layer may execute a handler program that emulates the unsupported instruction.

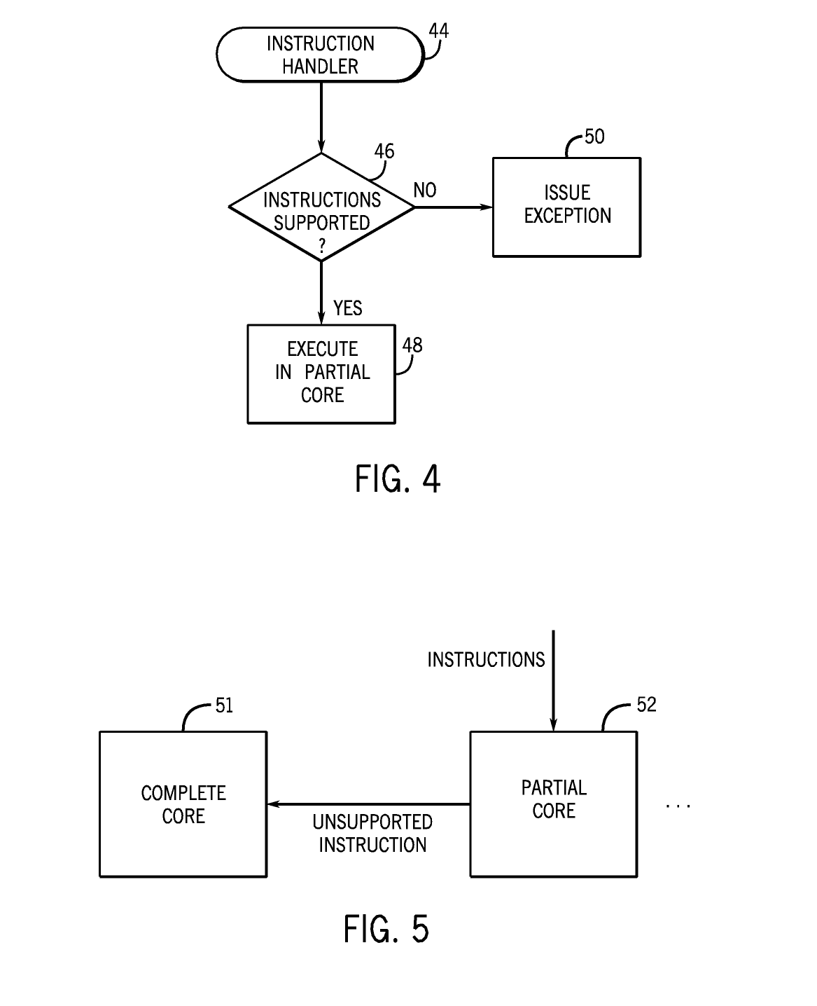

In some embodiments, a hybrid of this approach and the previously described approach, shown in FIGS. 2 and 3 may be used. Thus referring to FIG. 4, a sequence 44 may be implemented in software, firmware and/or hardware. In software and firmware embodiments the sequence may be implemented by computer executed instructions stored on a non-transitory computer readable medium such as a magnetic, optical or semiconductor storage.

The sequence 44 begins by determining whether the instruction is supported as indicated in diamond 46. If so, the instruction may be executed in the partial core as indicated in block 48. Otherwise an exception is issued as indicated in block 50.

In accordance with yet another embodiment, a processor may have one or two cores that include the full and complete instruction set and some number of partial cores that only implement a certain feature of the completed instruction set such as commonly executed features. Whenever a partial core comes across an unsupported instruction, the partial core transfers that task to one of the complete cores. The complete core in the mixed or heterogeneous environment can be hidden or exposed to operating systems. This approach does not involve any binary translation layer, either software or hardware in some embodiments, and differences in core features can be hidden from the operating system in other software layers.

Thus, referring to FIG. 5, the architecture may include at least one complete core 51 and at least one partial core 52. Instructions are checked by the partial core 52. If the instructions are unsupported then they are transferred to the complete core 51. Other cases where instructions are transferred, may also be contemplated.

In accordance with one embodiment of a partial core processor, the following instructions may be supported:

Data Transfer
bswap, xchg, xadd, cmpxchg, mov, push,
pop, movsx, movzx, cbw, cwd, cmovcc
Arithmetic
add, ade, sub, sbb, imul, mul, idiv, div,
inc, dec. neg, cmp
Logical
and, or, xor, not
Shift and Rotate
sar, shr, sal, shl, ror, rol, rer, rcl
Bit and Byte
bt, bts, btr, btc, test
Control Transfer
jmp, jcc, call, ret, iret, int, into
Flag Control
stc, clc, cmc, pushf, popf,
sti, cli
Miscellaneous
lea, nop, ud2
System
lidt, lock, sidt, hlt, rdmsr, wrmsr

The following instructions may not be supported in accordance with one embodiment:

Data Transfer
cmpxchg8b, pusha, popa
Decimal Arithmetric
daa, das, aaa, aas, aam, aad
Shift and Rotate
shrd, shld
Bit and Byte
setee, bound, bsf, bsr
Control Transfer
enter, leave
String
movsb, movsw, movsd, cmpsb, cmpsb,
cmpsw, cmpsd, scash, scasw, scads,
loadsb, loadsw, loaded, stosb, stows,
stosd, rep, repz, repnz
I/O
in, out, insb, insw, insd, outsb, outsw,
outsb
Flag Control
eld, std, lahf, sahf
Segment Register
lds, les, lfs, lgs, lss
Miscellaneous
xlat, cupid, movebe
System
lgdt, sgdt, lldt, sldt, ltr, str, lmsw, smsw,
clts, arpl, lar, lsl, verr, verw, invd, wbinvd,
invlpg, rsun, rdpmc, rdtsep, sysenter,
sysexit, xsave, xrestr, xgetbv, xsetbv

In some embodiments, a configurable partial core may be produced with the appropriate circuit elements and software. In one embodiment, the user can enter selections in response to graphical user interfaces. Then the system automatically generates the register transfer level (RTL) and software to implement a partial core with those features. In some embodiments, the instructions set is predefined and further configurability may be offered. In other embodiments, a system may enable the user to manually implement configuration selections. As an example, one system may permit configuration of caches, branch predictors, pipeline bypasses, and multipliers.

For example, in one embodiment, a cache configuration may be set by default with tightly coupled data and instruction caches. Among the options that may be selected includes split data and instruction caches and selectable cache parameters, such as cache size, line size, associativity, and error correction code.

Branch predictors may be set by default using the always not-taken approach to conditional branching. Selectable options, in some embodiments, may include backwards taken and forwards not-taken, branch target buffers of two, four, eight or sixteen entries, full scale G-share based, or a predictor with a configurable number of entries.

A set of default pipeline bypasses may be selectively deactivated in one embodiment. Default bypasses allow users to trade off performance for higher frequency but at the expense of power. For example, a bypass called IF_IBUF allows data coming from the instruction memory/cache to go directly to the predecoder and decoder stages without first going into the instruction buffer. Similarly, there is another bypass in some embodiments that sends results from a compare instruction, to operand fetch and instruction stages for quickly determining if a jump instruction, that is the next compare instruction, results in jumping into a different location or not. Based on this information, the instruction fetch unit can start fetching instructions starting at the new address. This bypass reduces the penalty for conditional jump instructions. While these bypasses offer higher efficiency, they do so at the cost of frequency. If a particular application needs higher frequency, then these bypasses can be selectively turned off at design time.

Still another set of options relates to the multiplier. A default configuration in one embodiment may offer one, two or multiple cycle multipliers. The user can choose one of these three multipliers based on a user's requirements. The single cycle multiplier takes more area and may limit the design from reaching higher frequencies but only takes one cycle to execute 32×32 bit multiplication operations. The multi-cycle multiplier on the other hand takes about 2,000 gates versus 7,000 gates for a single cycle multiplier, but takes more than one cycle to execute 32×32 bit multiplier operations.

In some embodiments other configurable features including memory protection unit, memory management unit, write back buffer may be made available. It can also be extended to the floating point unit, single instruction multiple data, superscalar, and number of supported interrupts to mention some additional configurable features.

In some embodiments, some selectable features are performance oriented, as is the case by with bypasses, branch predictors and multipliers, and others are functionality or feature oriented such as those related to caches, memory protection units and memory management units.

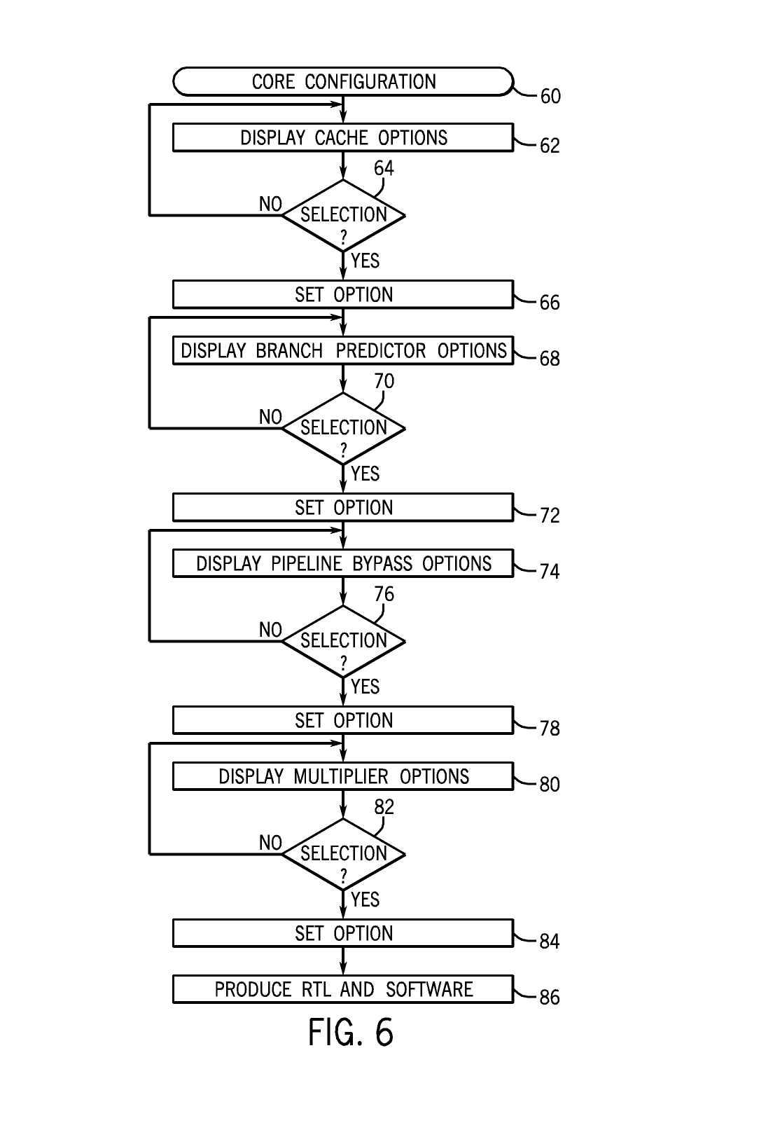

Referring to FIG. 6, a core configuration sequence 60 may be implemented in software, hardware and/or firmware. In software and firmware embodiments it may be implemented by computer executed instructions stored in a non-transitory computer readable medium such as an optical, magnetic or semiconductor storage.

In one embodiment, the sequence 60 begin by displaying selectable cache options for a partial core design as indicated in block 62. Once the user makes a selection, as indicated in diamond 64, the option is set as indicated in block 66, meaning that it will be recorded and ultimately be implemented into the necessary code without further user action in some embodiments. If a selection is not made, the flow simply awaits the selection.

Next branch prediction options may be displayed as indicated in block 68 followed by a selection check at diamond 70 and an option set stage at block 72.

Thereafter, pipeline bypass options may be displayed (block 74) followed by selection at diamond 76 and option setting at block 78. Next, multiplier options may be displayed as indicated at block 80. This may again be followed by a selection decision at diamond 82 and option setting at block 84.

Finally, all the options that have been set or selected are collected and the appropriate RTL and software code is automatically generated as indicated in block 86. Thus, based on the designer's selections, the necessary code to create the hardware and software configuration may be generated automatically in some embodiments.

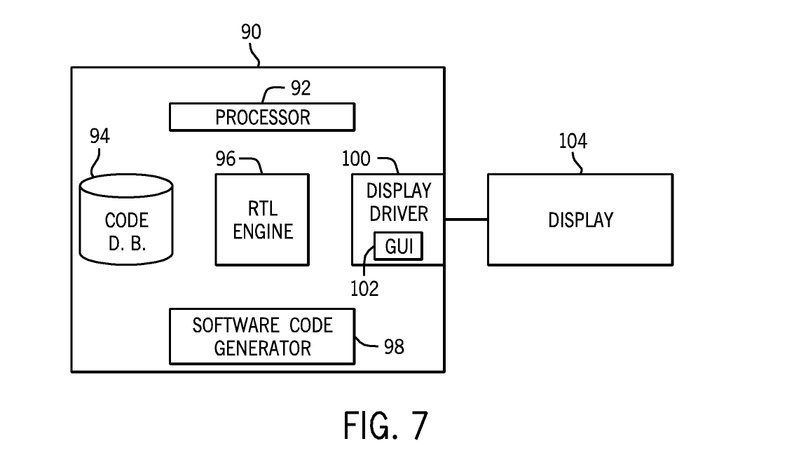

Referring to FIG. 7, a system 90 for implementing one embodiment to the present invention may include a processor 92 coupled to a code database 94, an RTL engine 96, a display driver 100 and a software code generator 98. Code database 94 stores the database of codes for the different selectable options. The RTL engine 96 includes the ability to generate RTL code in response to user selections. The software code generator generates the necessary software code to implement the user selections. The display driver 100 drives the display 104 and includes software for generating the graphical user interface (GUI) 102 in one embodiment that provides user selectability of various defined options.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
determining if an instruction is supported by a partial core;
only if the instruction is supported, providing said instruction for execution by the partial core;
providing a number of selectable partial core design options; and
based on user selections, automatically generating code to implement a partial core with the selections.

2. The method of claim 1 including executing an instruction not supported by the partial core by a complete core.

3. The method of claim 1 including executing an instruction not supported by the partial core by a pre-built handler.

4. The method of claim 1 including issuing an exception if an instruction is not supported by the partial core.

5. The method of claim 1 including excluding instructions from the instruction set of the partial core for handling read-only dependencies.

6. The method of claim 1 including translating instructions in hardware without fetching corresponding micro-operations from microcode read-only.

7. The method of claim 1 includes enabling cache configuration selections.

8. The method of claim 1 including enabling selection of branch predictors.

9. The method of claim 1 including enabling selection of pipeline bypasses.

10. The method of claim 1 including enabling selection of multipliers.

11. A non-transitory computer readable medium storing instructions to:
determine if an instruction is supported by a core that only executes some of the instructions of an instruction set;
only if the instruction is supported, provide said instruction for execution by the core;
provide a number of selectable partial core design options; and
based on user selections, generate code to implement a partial core with the selections.

12. The medium of claim 11, storing instructions to execute an instruction not supported by the core by a complete core.

13. The medium of claim 11, storing instructions to execute an instruction not supported by the core by a pre-built handler.

14. The medium of claim 11, storing instructions to issue an exception if an instruction is not supported by the partial core.

15. The medium of claim 11, storing instructions to exclude instructions from the instruction set of the core for handling read-only dependencies.

16. The medium of claim 11, storing instructions to translate instructions in hardware without fetching corresponding microoperations from microcode read-only memory.

17. The medium of claim 11, storing instructions to enable cache configuration selections.

18. The medium of claim 11, storing instructions to enable selection of branch predictors.

19. The medium of claim 11, storing instructions to enable selection of pipeline bypasses.

20. The medium of claim 11, storing instructions to enable selection of multipliers.

21. The apparatus comprising:
a processor to enable a user to select from among options for a processor core including cache design options; and
a code database storing code to implement selectable design options for a processor core, including register transfer level and a software code.

22. The apparatus of claim 21, said processor to enable selection of branch predictors.

23. The apparatus of claim 21, said processor to enable selection of pipeline bypasses.

24. The apparatus of claim 21, said processor to enable selection of multipliers.
